(19) United States
(12) Patent Application Publication
(10) Pub. No.: US 2003/0073061 A1
(43) Pub. Date: Apr. 17, 2003

(54) Breast lump detection training model with feedback

(76) Inventor: Timothy Daniel Toomey, Iowa City, IA (US)

Correspondence Address: Timothy D. Toomey, 526 N. Linn St., Iowa City, IA, 52245, US

(21) Appl. No.: 09/978,287

(22) Filed: Oct. 17, 2001

(51) Int. Cl. G09B 23/28

(52) U.S. Cl. 434/273

(57) ABSTRACT

The device is for the training of medical professionals and others in the detection of breast lumps. It addresses two deficiencies in other models; the ease of lump location memorization and lack of feedback in the detection of a lump. The device is a model of the human female breast consisting of the following tissue simulations; an exterior skin, an interior body, ribs, a base and multiple potential lumps. The notable innovation to breast lump trainers is the employment of tubes to simulate the breast lumps, supply feedback and reduce the user's ability to memorize lump locations. A fine elastic tube inflates at its tip to simulate a breast lump. The pressure applied to the tube is monitored and provides feedback indicating detection of a simulated breast lump. Multiples of these tubes are placed within the trainer body. The tube balloons can be inflated, or ‘turned on’, to variable sizes with air or fluid to simulate breast lumps. The tube balloons can be deflated, or ‘turned off’, and return to their original, difficult to detect, tube shape. The tubes exit the breast model through the base and are connected to a fluid pressure sensor, for breast lump detection feedback, and to an injector for inflating, deflating and changing the size of the lumps.

### CROSS-REFERENCE TO RELATED APPLICATIONS

Field of Search

434/267

U.S. Patent Documents

| | | | |
|---|---|---|---|
| 2580264 | Dec., 1951 | Wright et al. | 264/DIG |
| 3681787 | Aug., 1972 | Perras | 3/36 |
| 3742935 | Jul., 1973 | Baessler | 128/2 |
| 3811133 | May, 1974 | Harris | 3/36 |
| 4019209 | Apr., 1977 | Spence | 264/DIG |
| 4001951 | Jan., 1977 | Fasse | 434/267 |
| 4086666 | May, 1978 | Vaskys | 264/222 |
| 4134218 | Jan., 1979 | Adams | 434/267 |
| 4184214 | Jan., 1980 | Sharper et al. | 128/463 |
| 4199825 | Apr., 1980 | Knoche | 3/36 |
| 4317241 | Mar., 1982 | Knoche | 264/222 |
| 4364880 | Dec., 1982 | Howse | 264/28 |
| 4737109 | Apr., 1988 | Abramson | 434/267 |
| 4867686 | Sep., 1989 | Goldstein | 434/267 |
| 5273435 | Dec., 1993 | Jacobson | 434/267 |
| 5803746 | Sep., 1998 | Barrie et al. | 434/267 |

### STATEMENT REGARDING FEDERALLY SPONSORED RESEARCH OR DEVELOPMENT

Not applicable

### REFERENCE TO A MICROFICHE APPENDIX

Not applicable

### BACKGROUND OF THE INVENTION

Breast cancer afflicts over forty thousand Americans yearly (1998). Early detection of breast lumps is the most important factor in the successful treatment of breast cancer. Statistics change over time and it is now projected that 1 in 8 women will develop breast cancer. A mammogram is the preferred method of detection but, due to exposure to ionizing radiation, the frequency of use is limited. Hand detection by palpation has no frequency of use limits and may be performed at any time. It has been shown that training improves the skill of health care providers in lump detection. By developing and refining the skills needed, the ability to detect tumors or lumps is enhanced. The dynamic breast lump detection trainer with feedback is a device to train professionals and others in the detection of lumps.

Two deficiencies in previous models are addressed. The first is ease of memorization. Other models use a limited number of static lumps. One model on the market has a removable bottom cover that allows observation of the interior placement of the lumps. This visually reinforces memorization. After a few uses a user memorizes the position of the lumps and the training device is no longer effective. This new device allows for a plurality of very small tubes to be placed in the model. Each individual tube is modified to inflate and balloon at its tip. The inflated tube tip simulates a breast lump. The tube is deflated to remove the lump. The size of the lumps can also be varied by the degree of inflation or by the size of the tubing used. The choice of fluid used to inflate the tubing balloons, the size of the tube and the degree of inflation allows for variations in the hardness of the simulated breast lumps.

The second deficiency in other models is a lack of direct feedback. This device employs a fluid pressure sensor to directly detect the palpation detection of a lump. This provides a simple, direct and accurate way of generating lump detection feedback.

### BRIEF SUMMARY OF THE INVENTION

The invention is a dynamic breast lump trainer with feedback. The major innovations in the trainer are the use of small, elastomeric tubing that can be inflated at its tip to simulate lumps. The tubing also provides direct access for a fluid pressure sensor to generate feedback.

The exterior surface of the device is an elastomer that models human skin. The interior body of the device is a soft elastomer that models breast tissue. Enclosed in the breast body are pluralities of very small, soft elastomeric tubes that have the ability to be inflated and balloon at their tips. The balloons simulate breast lumps and are inflatable to different sizes. When deflated they return to their original tube shape and are undetectable as lumps. Rib and underlying body structures are simulated and placed beneath the body and form the base. The base protects the interior and provides an exit for the tubing. Individual tubes can be inflated to a desired size with air, water or a fluid of suitable density. Lump detection feedback is generated by fluid pressure sensors, which detect pressure or changes in pressure in the tubes when palpated. Inflation of the tubing can be accomplished with a syringe, a pump or pressure tank.

### BRIEF DESCRIPTION OF THE DRAWINGS

FIG. 1 is an assembly view of the device, showing individual components.

FIG. 2 is a cut side view showing the device.

FIG. 3 is a drawing of the “Y” connecter (object no. 6) used to interconnect a tube, a pressure sensor and an injector.

FIG. 4 is a block diagram of a computer-controlled configuration that incorporates the breast lump model device.

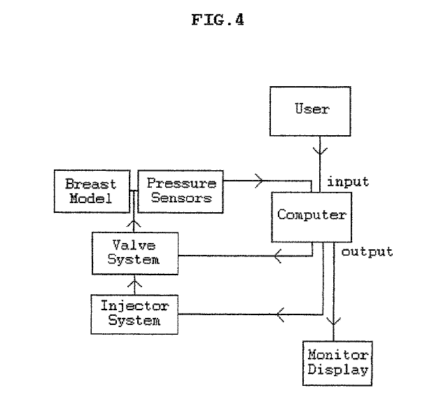

### OBJECTS OF THE INVENTION

1. A skin or protective, exterior, elastomeric covering

2. An elastomeric body or interior of the breast model

3. Simulated ribs

4. A base, which protects the interior, models underlying anatomical structures, and serves as an exit for tubing

5. Elastomeric tubing used to balloon into lumps

6. A ‘Y’ connector, to interconnect a tube, a sensor and an injector

7. A pressure sensor to generate feedback

8. An injector to inflate the balloon tubing

### DETAILED DESCRIPTION OF THE INVENTION

The breast lump training model with feedback is constructed following a step-by-step process. The example here is the preferred embodiment of the trainer.

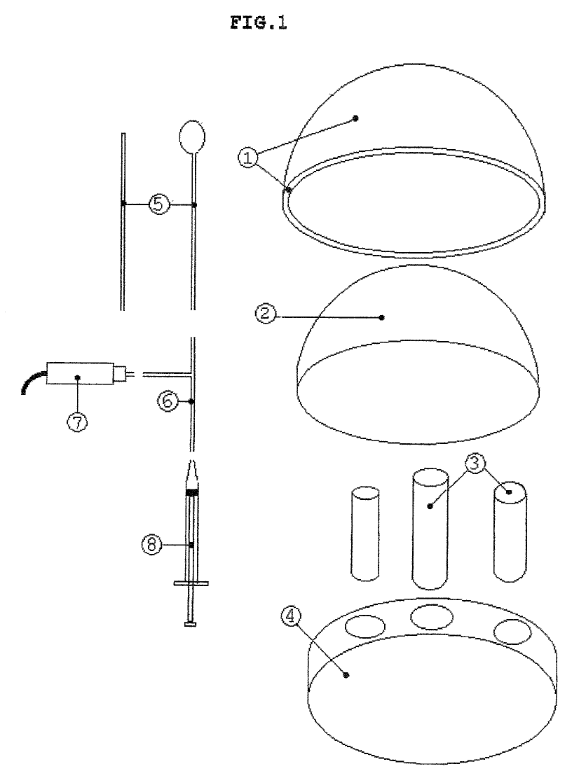

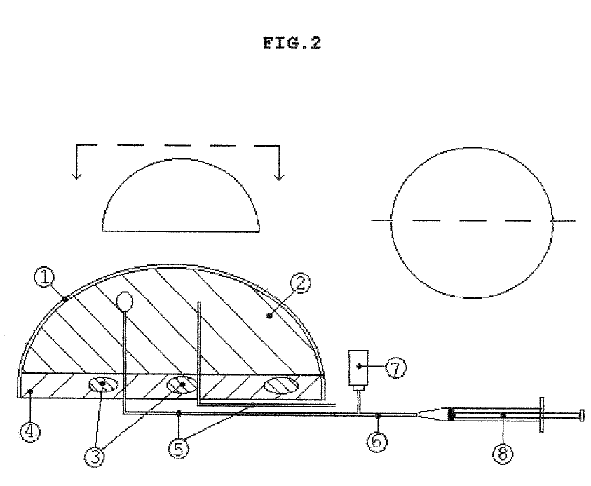

Referring to FIG. 1 (object 5) and FIG. 2 (object 5) the lump tubes are made by sealing the end of a 6 to 8 inch section of tubing. One method for sealing the end is to tie a knot in the tubing. The tubing is then repeatedly flexed in the area of the knot to relax the cross-linking bonds. After being sealed and sufficiently flexed, injected air or fluid causes the tubing to balloon at the tip. Two sizes of silicone tubing, manufactured by Silastic Inc., are used. The larger of the two has an ID of 0.058″ and an OD of 0.066″. The smaller tubing has an ID of 0.025″ and an OD of 0.045″.

Referring to FIG. 1 (object 3) and FIG. 2 (object 3) the ribs are made from hard silicone manufactured by Dow and acquired from any hardware store. The silicone is extruded from its tube onto wax paper and shaped with a rubber spatula into the size and form of human ribs.

Referring to FIG. 1 (object 2) and FIG. 2 (object 2) the body is made with a silicone gel, P-157, manufactured by Silicone Inc., mixed with a cross linking additive, P-157-A, also from Silicone Inc. Depending on the age group that is being modeled, the cross linking additive is added as a percentage of weight of the gel. 9% to 10% is used for an 18 year old. 7% is the approximate amount for a 60 year old. After a thorough mixing of the gel and additive, the silicone is placed in a vacuum chamber to remove gas bubbles. The silicon is then poured into a breast shaped mold, pre-coated with a release agent, and the tubing sections (object 5) are suspended into the silicone at the desired placement. Any number of tubing sections may be placed. Allow two days for the silicone to fully cure at room temperature.

Referring to FIG. 2, an additional half inch of silicone and the ribs (object 3) are added to the mold to form the base (object 4). The silicone used is GI-245 with 10% by weight GI-245-A, a cross linking additive, both manufactured by Silicone Inc. Preparation of the silicone is the same as for P-157. At this point the tubing sections (object 5) are aligned in the base (object 3) to exit the model. Allow two additional days for curing. The partially assembled model may then be removed from the mold.

Referring to FIG. 2, the exterior skin (object 1) is then applied. A silicone GI-245 with 10% by weight GI-245-A is used. GI-245 also has additives that can color the skin to flesh tones. Preparation of the silicone is the same as described previously. The silicon skin (object 1) is poured over the body (object 2) and the excess is allowed to drip off. After two days of curing, the excess hanging drips may be trimmed off. Talc powder can be applied to reduce friction and give it the feel of human skin.

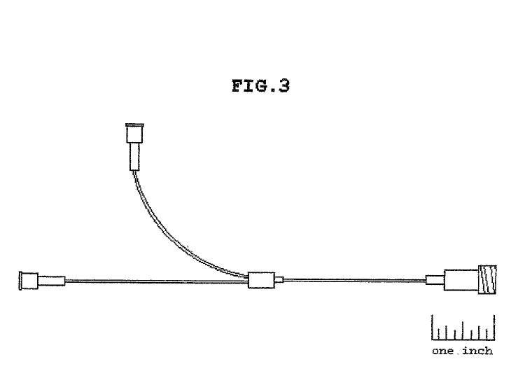

Referring to FIG. 1, FIG. 2 and FIG. 3, an external end of the tubing (object 5) is joined to a pressure sensor (object 7) and syringe (object 8) via a Y connector (FIG. 3, object 6). For the smaller tubing (object 5), with ID of 0.025″ and an OD of 0.045″, a 23G syringe needle with a blunted end is inserted. For the larger tubing (object 5), with ID of 0.058″ and an OD of 0.066″, a 16G blunted needle is used. A ‘Y’ extension set, with mini-bore tubing and Luer locks (object 6 and FIG. 3) manufactured by Codan, is used to interconnect the pressure sensor (object 7), a tube (object 5) and a syringe (object 8). One leg of the Y (object 6) is attached to tube (object 5), the other, to a pressure transducer (object 7). A 1 Ml disposable

I claim:

1. The first embodiment is a dynamic breast model device with feedback, for training in the detection of breast lumps comprising:
a) elastomeric tubing, with a ballooning tip, to model breast lumps;
b) an interior body made of an elastomer to model human breast tissue;
c) sub-interior structures that model human tissue structures and ribs;
d) an exterior made of an elastomer that models human skin;
e) pressure sensors to detect the pressure, and changes in pressure, in the tubing;
f) injectors that inflate the tubing;

2. A method of injection for the device according to claim 1 where the injector is a syringe, a pump, a motor, or pressure tank.

3. A method of feedback for the device according to claim 1 where a fluid pressure sensor detects the palpation of a lump.

4. A method of feedback for the device according to claim 1 and claim 3 where the sensor detection of a lump is confirmed visually or audibly

5. A method of feedback for the device according to claim 1 where a sensor provides feedback indicating lump inflation.

6. The device according to claim 1 with multiple tubing sections, where each tube may independently be inflated into lumps, are contained in the body of the device.

7. The device according to claim 1 where the elastomers used are silicone, latex, plastic, rubber or related elastomers.

8. A second embodiment is a device comprised of:
a) the first embodiment of the device of claims 1, 2, 3, 4, 5, 6 and 7;
b) a computer that inputs data from a user, pressure sensors of claim 1, and injector system of claim 1;
c) a computer that outputs data to a display, a valve system and an injector system of claim 1;
d) a computer controlled valve system that opens or closes the tubing of claim 1;
e) a computer controlled injection system that inflates the tubing of claim 1;
f) a monitor or display;
